(19) United States
(12) Patent Application Publication
(10) Pub. No.: US 2025/0250800 A1
(43) Pub. Date: Aug. 7, 2025

(54) WALLCOVERING PANEL

(71) Applicant: Hyperform Inc., Rockledge, FL (US)

(72) Inventor: Jeff Schieman, Indian Harbour Beach, FL (US)

(21) Appl. No.: 19/037,912

(22) Filed: Jan. 27, 2025

Related U.S. Application Data
(60) Provisional application No. 63/627,887, filed on Feb. 1, 2024.

(51) Int. Cl. E04F 13/08; B44F 9/02

(52) U.S. Cl. CPC E04F 13/0885; B44F 9/02; E04F 13/0866

(57) ABSTRACT

A wallcovering panel includes a semi-rigid foam substrate including opposite first and second surfaces, the semi-rigid foam substrate having a first density, at least one foam layer including a first side and a second side opposite the first side of the at least one foam layer, where the second side of the at least one foam layer is laminated to the first surface of the semi-rigid foam substrate, and the at least one foam layer has a second density that is less than the first density, an etched pattern defined on the first side of the at least one foam layer, and a pressure sensitive adhesive layer disposed on the second surface of the semi-rigid foam substrate and configured to couple the wallcovering panel to a wall surface and to allow the wallcovering panel to be peelably removed from the wall surface without damage thereto.

### CROSS REFERENCE TO RELATED APPLICATIONS

This application claims benefit to U.S. Provisional Patent Application No. 63/627,887, filed Feb. 1, 2024, entitled “WALLCOVERING PANEL,” the entire disclosure of which is being incorporated herein by reference.

### BACKGROUND OF THE INVENTION

The embodiments as shown and described herein relate to a wallcovering panel and a method of manufacturing a wallcovering panel.

### SUMMARY OF THE INVENTION

One embodiment as shown and described herein includes a wallcovering panel that includes a semi-rigid foam substrate having a first surface and a second surface, opposite the first surface, where the semi-rigid foam substrate has a first density, at least one foam layer including a first side and a second side that is opposite the first side of the at least one foam layer, where the second side of the at least one foam layer is laminated to the first surface of the semi-rigid foam substrate, and the at least one foam layer has a second density that is less than the first density, an etched textured pattern defined on the first side of the at least one foam layer, and a pressure sensitive adhesive layer disposed on the second surface of the semi-rigid foam substrate, where the pressure sensitive adhesive layer is configured to couple the wallcovering panel to a wall surface, and where the pressure sensitive adhesive layer is configured to allow the wallcovering panel to be peelably removed from the wall surface without damage to the wall surface.

Another embodiment of the wallcovering panel as shown described herein may further or alternatively include a foam substrate having a first side and a second side that is opposite the first side, where the foam substrate has a first density, a foam layer including a first side and a second side that is opposite the first side of the foam layer where the second side of the foam layer is attached to the first side of the foam substrate, and where the foam layer has a second density that is less than the first density, and an adhesive layer disposed on the second side of the foam substrate, where the adhesive layer is configured to couple the wallcovering panel to a surface, and where the adhesive layer allows the wallcovering panel to be removed from the surface; and a pattern defined on the first side of the foam layer.

Still yet another embodiment as shown and described herein may include a method of manufacturing a wallcovering panel where the method includes providing a foam sheet including a first side and a second side opposite the first side, providing at least one semi-rigid substrate including a first side and a second side opposite the first side of the semi-rigid substrate, laminating the second side of the foam sheet to the first side of the at least one semi-rigid substrate, etching the first side of the foam sheet to form a textured pattern, and applying a pressure sensitive adhesive to the second side of the at least one semi-rigid substrate, where the pressure sensitive adhesive allows the wallcovering panel to be secured to a wall surface, and where the wallcovering panel is peelably removable from the wall surface without damage to the wall surface.

Another embodiment as shown and described herein may further or alternatively include a wallcover panel that includes a first portion that having a first side, where the first portion has a first density, and a second portion including a second side opposite the first side of the first portion, where the second portion is integrally formed with the first portion, and where the second portion has a second density that is different than the first density, an adhesive disposed on the second side of the second portion, where the adhesive allows the wallcover panel to be removably coupled to a wall surface without damage to the wall surface, and a pattern etched into the first side of the first substrate.

These and other advantages of the embodiments as disclosed and described herein will further be understood and appreciated by those skilled in the art by reference to the following specification, claims, and appended drawings.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 is a top perspective view of a wallcovering panel in which the release layer is visible;

FIG. 2 is a bottom perspective view of the wallcovering panel in which the textured pattern is visible;

FIG. 3 is an end elevation view of the wallcovering panel;

FIG. 4 is a side end elevation view of a plurality of wallcovering panels secured to a wall surface; and

FIG. 5 is a schematic flowchart of a method of manufacturing the wallcovering panel.

### DETAILED DESCRIPTION OF THE INVENTION

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

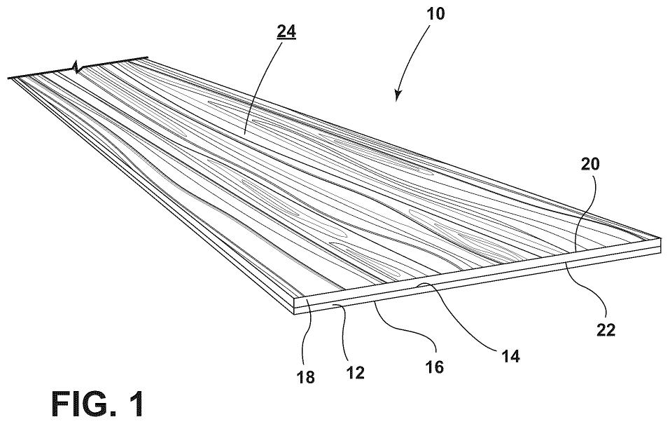

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

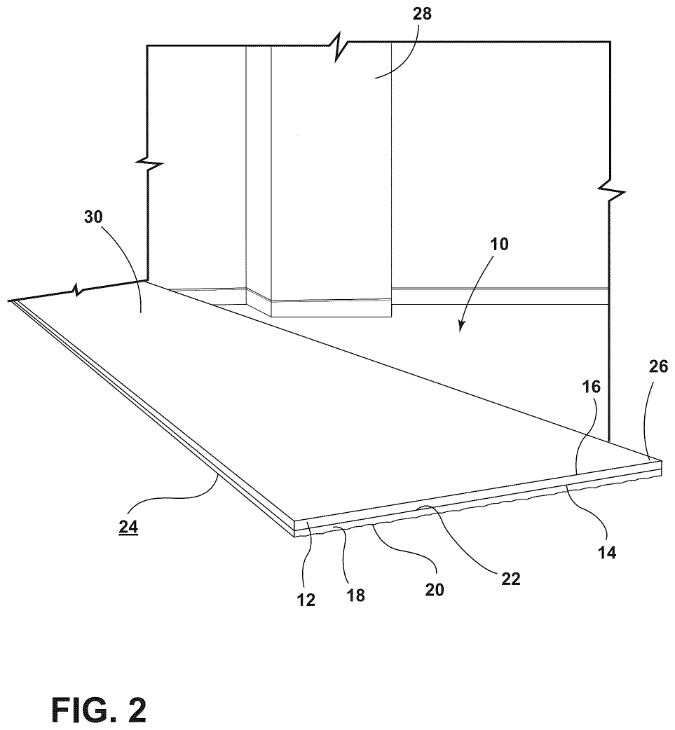

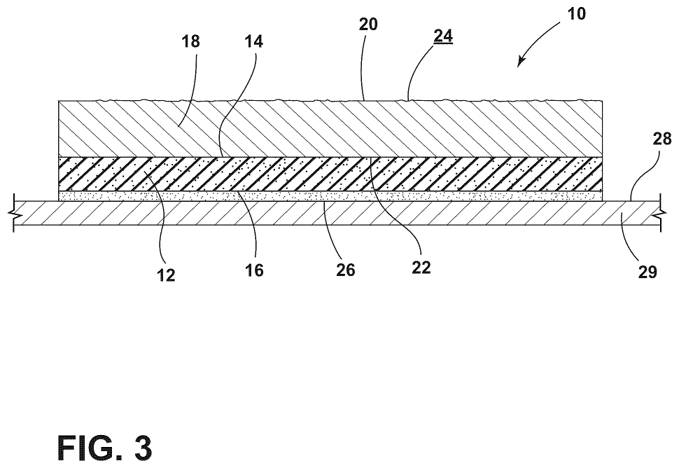

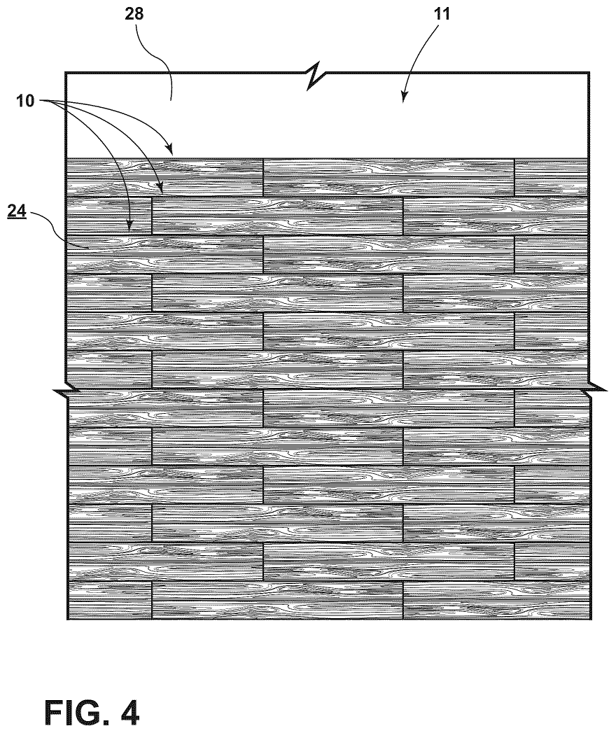

Reference numeral 10 (FIGS. 1-5) generally designates a wallcovering panel 10 that is configured such that a plurality of the wallcovering panels 10 (FIG. 4) may be utilized to cooperate to provide an overall aesthetic wall covering 11. In the first illustrated example, each wallcovering panel 10 includes a foam substrate 12, a foam layer 18 and an adhesive layer 26. In the illustrated example, the foam substrate 12 includes a first surface 14 and a second surface 16 that is opposite the first surface 14. The foam layer 18 includes a first side 20 and a second side 22 that is opposite the first side 20 of the foam layer 18. While shown as a single layer the foam layer 18 may include a plurality of layers secured to one another via lamination, adhesives, sonic welding, vibrational welding, and the like. As shown, the second side 22 of the at least one foam layer 18 laminated to the first surface 14 of the foam substrate 12, however, the foam layer 18 may be secured to the foam substrate 12 via other methods including, but not limited to, adhesives and chemical bonding, sonic welding, vibrational welding, and the like. In the present example, the foam substrate 12 has a first density and the foam layer 18 has a second density and the foam layer 18 has a second density that is different than the first density. Specifically, the foam layer 18 has a density that is less than the density of the density of the foam substrate 12. In other embodiments, the foam substrate 12 and the foam layer 18, as well as additional foam layers, may have the same or similar densities. In yet other embodiments, the foam substrate 12 and the foam layer 18 may be provided as a single integrated layer where the density of the single layer may vary or be consistent throughout. In addition, the various layers may be provided at varying thicknesses where the foam substrate 12 has a thickness that is greater or less than a thickness of the foam layer 18 or multiple foam layers. The wallcovering panel 10 also includes a textured pattern 24 defined on the first side 20 of the foam layer 18. The adhesive layer 26 disposed on the second surface 16 of the foam substrate 12 is configured to attach the wallcovering panel 10 to a wall surface 28 of a wall 29 and is further configured to allow the wallcovering panel 10 to be peelably removed from the wall surface 28 without damage to the wall surface 28, as described below. Although shown as having a generally rectangular overall shape, the wallcovering panel 10 may have a shape such that a plurality of the panels cooperate to cover a given wall surface 28.

Still referring to FIGS. 1-3, the foam substrate 12 includes at least one of a semi-rigid foam material with flexibility and stiffness properties intermediate of resilient flexible foams and rigid set plastic materials. The semi-rigid quality of the foam substrate 12 imparts enhanced tear resistance and handling capability compared to low density flexible foams while maintaining sufficient pliability for conforming the panel to wall surfaces 28, particularly, wall surfaces 28 that are curved, and further allows the wallcovering panel 10 to be easily removed from the wall surface 28 as a single piece and without tearing or partial removal of each wallcovering panel 10. The foam substrate 12 may include, but is not limited to, lightweight closed cell plastic foams such as polyurethane foams, expanded polystyrene foams, EVA foams, polyethylene foams, and other varying materials that are of a semi-rigid or foldable quality. As used herein, “EVA” includes within its meaning ethylene-vinyl acetate. In embodiments, EVA material may be in sheet form. Preferably, the foam substrate 12 also includes the first density of between about 4 lbs/ft³ and about 15 lbs/ft³, more preferably of between about 7.5 lbs/ft³ and about 9 lbs/ft³, and most preferably about 8.5 lbs/ft³, and a thickness of between about 1/16 inch and about 2 inches, more preferably of between about 1/16 inch and about ½ inch, and most preferably of between about 1/16 inch and about ¼ inch.

The foam layer 18 may comprise a single foam layer or a plurality of foam layers to form a layered composite substrate, as discussed above. The foam layer 18 may comprise polymer foams, including but not limited to, polyurethane, polystyrene, polyethylene, neoprene, polypropylene or ethyl-vinyl acetate (EVA) of either high or low density. The foam layer 18 may also include potions of varying densities. The density of the foam layer 18 preferably ranges from about 1 lbs/ft³ to 15 lbs/ft³, more preferably of between about 1 lb/ft³ and about 8.5 lbs/ft³, and most preferably of between about 1 lb/ft³ and about 7.5 lbs/ft³, and a thickness preferably of between about 1/16 inch and about 2 inches, more preferably of between about ½ inch and about ⅞ inch, and most preferably of between about 11/16 inch and about 13/16 inch.

The foam layer 18 also includes a textured pattern 24 on the first side 20 of the at least one foam layer 18. In the illustrated example, the textured pattern 24 is etched into the first side 20 of the at least one foam layer 18 via a laser. Alternatively, the textured pattern 28 may be created via mechanical means such as with a CNC machine, via water jet, and the like. The textured pattern 24 may simulate a variety of finishes, including but not limited to, a wood grain pattern.

The adhesive layer 26 is disposed on the second surface 16 of the foam substrate 12. The adhesive layer 26 may comprise a pressure sensitive adhesive film that is laminated, e.g., thermally, or adhered using UV-cure, moisture-cure, or two-part chemical technology adhered to the second surface 16 of the foam substrate 12. The pressure sensitive adhesive film may include, but is not limited to, microsphere adhesive, acrylic, silicone, modified acrylate copolymer, and polyurethane compositions usable in both indoor and outdoor wall surface 28 applications.

The wallcovering panel 10 (FIG. 1) may further include a release layer 30 that is coupled to the adhesive layer 26. The release layer 30 includes, but is not limited to, a film or a coated film paper, such as a silicone-coated paper with controlled release properties to enable easy separation from the adhesive layer 26, a polyester or polyethylene film, and other suitable materials.

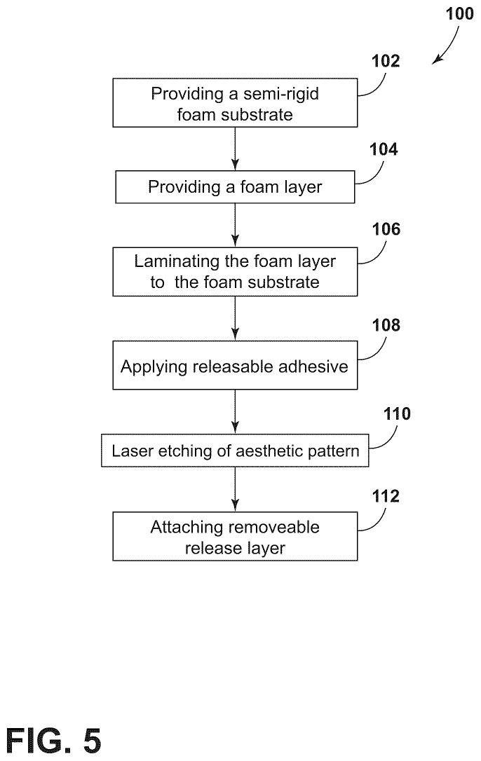

The wallcovering panel 10 may be constructed via a method 100 that includes providing 102 (FIG. 5) a semi-rigid foam substrate 12, providing 104 the foam layer 18 and laminating 106 the foam layer 18 to the foam substrate 12 via a roll lamination process, e.g., a flame lamination process, where the foam substrate 12 and the foam layer 18 are passed between two counter-rotating stainless steel rolls. As the foam substrate 12 and the foam layer 18 pass through the heated rolls, the foam substrate 12 and the at least one foam layer 18 enter a softened semi-molten state allowing the first surface 14 of the foam substrate 12 and the second side 22 of the at least one foam layer 18 to laminate through a fusing process under pressure at the point forming a laminated foam structure. The roll lamination process creates a strong laminate bond between the foam substrate 12 and the at least one foam layer 18 without the use of adhesives or mechanical fasteners. The resulting laminated foam composite structure provides enhanced stiffness, durability, and structural integrity for use in the wallcovering panel 10.

The adhesive layer 26 is applied 110 to the second surface 16 of the foam substrate 12 through a coating process. The pressure sensitive adhesive film of the adhesive layer 26 includes, but is not limited to, an acrylic, silicone or polyurethane film that is thermally fused to the second surface 16 of the foam substrate 12 by passing the materials through a set of heated laminating rolls, where the heat and pressure bonds the pressure sensitive adhesive film to the second surface 16 of the foam substrate 12.

The textured pattern 24 of the wallcovering panel 10 may be laser etched 108 via a carbon dioxide laser that is controlled via computer numerical control (CNC) software to scan the surface of the foam layer 18 to selectively ablate and cut cavities out of the foam layer 18 based on a pre-programmed pattern digitized, preferably from an actual wood surface or graphical artwork. Precision laser ablation of the microscopic foam cavities results in a textured pattern 24 extending into the at least one foam layer 18 with three-dimensional depth and surface variation that closely replicates the visual and physical depiction of wood grain. The laser etching technique provides precision patterning to create naturalistic three-dimensional texture on the first side 20 of the at least one foam layer 18. A translucent decorative layer (not shown) may be applied over the laser-etched surface 24 as part of the finished wallcovering panel 10.

The pressure sensitive adhesive qualities of the adhesive layer 26 enables the wallcovering panel 10 to be mounted onto a wall surface 28 without requiring additional liquid adhesives or pastes. The adhesive layer 26 has a peel adhesion strength to the wall surface 28 preferably of between 2 lbs/in² and about 6 lbs/in², more preferably of about 3-5 lbs/in², and most preferably of about 4 lbs/in², each allowing the wallcovering panel 10 to be pulled off of the wall surface 28 without damage to the underlying wall surface 28, including surfaces comprising drywall or gypsum board, painted or unpainted. The release force of the adhesive layer 26 is sufficient to hold the wallcovering panel 10 under normal conditions but allows clean removability without adhesive residue being left on the original wall surface 28. The wallcovering panel 10 can thereby be repositioned or entirely replaced with a new wallcovering panel 10 in a continuous “peel-and-stick” fashion to avoid damage or need to refinish the underlying wall surface 28, and/or to prevent significant or permanent damage to the wall surface 28.

A release layer 30 may be removably and temporarily attached 112 to cover and protect the adhesive layer 26 against contaminants during shipping, storage and handling, while allowing clean detachment from the adhesive layer 26 for wallcovering panel 10 mounting. The release layer 30 may be treated with a release agent to facilitate a controlled bond to the adhesive layer 26 so as to be easily peeled away without adhesive residue remaining. Suitable release agents include, but are not limited to, polysiloxanes and fluoropolymers.

In an alternate embodiment, the adhesive layer 26 comprises a fluid-applied acrylic emulsion polymeric material having a viscosity between 5,000 and 50,000 centipoise. The pressure sensitive adhesive is drawn from a holding reservoir and pumped at a controlled flow rate configured to achieve specified adhesive coat weight and uniformity. As the second surface 16 of the foam substrate 12 passes below the slot die coater head on a conveyor system, the adhesive layer 26 is rolled and smoothed to cover the second surface 16 of the foam substrate 12. The adhesive layer 26 is applied between approximately 0.05 mm and 0.15 mm thick on the foam substrate 12 and rapidly cured using heat lamps or forced hot air circulation. Full cure and adhesion strength is achieved after 12-24 hours. The coating process allows efficient, precise application of the pressure sensitive adhesive layer 26 to provide consistent bonding performance in the finished wallcovering panel 10.

In another alternate embodiment, the adhesive layer 26 comprises a two-part chemical cure adhesive composition applied to the second surface 16 of the foam substrate 12. The two-party epoxy or polyurethane adhesive components are mixed immediately prior to a controlled spray coating application, which uniformly blankets the second surface 16 of the foam substrate 12. The spray applied adhesive layer 26 then cures at room temperature or an elevated temperature to bond the adhesive layer 26 to the foam substrate 12.

In yet another embodiment, the adhesive layer 26 comprises a hot melt adhesive web applied through a melt blown process onto the foam substrate 12 prior to cooling and solidifying on the second surface 16. The hot meld adhesive provides immediate bond strength upon cooling without extended cure times.

According to at least one aspect, the method of manufacturing a wallcovering panel 10, as discussed above, includes: (i) providing 102 the semi-rigid substrate 12 including the first side 14 and the second side 16 opposite the first side 14; (ii) providing 104 a foam sheet 18 including the first side 20 and the second side 22 opposite the first side 20; (iii) laminating 106 the second side 20 of the foam sheet 18 to the first side 14 of the semi-rigid substrate 12; (iv) applying 108 a pressure sensitive adhesive to the second side 16 of the semi-rigid substrate 12, where the pressure sensitive adhesive allows the wallcovering panel to be secured to a wall surface, and where the wallcovering panel is peelably removable from the wall surface without damage to the wall surface 28; (v) etching 110 the first side 20 of the foam sheet 18 to form a textured pattern 24; and (vi) attaching 112 the release layer 30 to the pressure sensitive adhesive. The method may also include applying a peelable surface over the adhesive to protect the adhesive from contamination prior to installation on the wall surface.

In the various embodiments, any of the described features or elements of the invention may be present in any combination, and in any number. It is not necessary that each and every described feature and element be present in each embodiment of the invention, or that any particular embodiment of the invention comprise only features of one type or another. Thus, the various features of the invention may be mixed in any embodiment, may be present in any number, or may not be present.

What is claimed is:

1. A wallcovering panel, comprising:
a semi-rigid foam substrate including a first surface and a second surface opposite the first surface, where the semi-rigid foam substrate has a first density;
at least one foam layer including a first side and a second side opposite the first side of the at least one foam layer, where the second side of the at least one foam layer is laminated to the first surface of the semi-rigid foam substrate, where the at least one foam layer has a second density that is less than the first density;
an etched textured pattern defined on the first side of the at least one foam layer; and
a pressure sensitive adhesive layer disposed on the second surface of the semi-rigid foam substrate, where the pressure sensitive adhesive layer is configured to couple the wallcovering panel to a wall surface, and where the pressure sensitive adhesive layer is configured to allow the wallcovering panel to be peelably removed from the wall surface without damage to the wall surface.

2. The wallcovering panel of claim 1, wherein the at least one foam layer includes an ethylene-vinyl acetate foam.

3. The wallcovering panel of claim 1, wherein the etched textured pattern is laser etched.

4. The wallcovering panel of claim 1, wherein the etched textured pattern comprises a visual depiction of a wood grain.

5. The wallcovering panel of claim 1, further comprising:
a release layer removably coupled to the pressure sensitive adhesive layer, wherein the release layer includes at least one of a film or a release coat paper.

6. The wallcovering panel of claim 1, wherein the pressure sensitive adhesive layer includes a removable adhesive that comprises at least one of an acrylic or silicone adhesive.

7. The wallcovering panel of claim 6, wherein the removable adhesive of the pressure sensitive adhesive includes at least one of a microsphere adhesive, polyurethane, or modified acrylate copolymer.

8. The wall covering panel of claim 1, wherein the shear resistance of the pressure sensitive adhesive is between 2 and 4 pounds per inch.

9. A wallcovering panel, comprising:
a foam substrate including a first side and a second side opposite the first side, where the foam substrate has a first density;
a foam layer including a first side and a second side opposite the first side of the foam layer, where the second side of the foam layer is attached to the first side of the foam substrate, where the foam layer has a second density;
an adhesive layer disposed on the second side of the foam substrate, where the adhesive layer is configured to couple the wallcovering panel to a surface, and where the adhesive layer allows the wallcovering panel to be removed from the surface; and
a pattern defined on the first side of the foam layer.

10. The wallcovering panel of claim 9, wherein the foam substrate comprises a semi-rigid substrate.

11. The wallcovering panel of claim 9, wherein the foam layer is laminated to the foam substrate.

12. The wallcovering panel of claim 9, wherein the foam substrate is integrally connected to the foam layer.

13. The wallcovering panel of claim 9, wherein the adhesive layer is a pressure-sensitive adhesive.

14. The wallcovering panel of claim 9, wherein the wallcovering panel is configured to be peelably removable from the wall surface without damage to the wall surface.

15. The wallcovering panel of claim 9, wherein the pattern comprises a textured pattern.

16. The wallcovering panel of claim 9, wherein the second density is less than the first density.

17. A method of manufacturing a wallcovering panel, comprising:
providing a foam sheet including a first side and a second side opposite the first side;
providing at least one semi-rigid substrate including a first side and a second side opposite the first side of the semi-rigid substrate;
laminating the second side of the foam sheet to the first side of the at least one semi-rigid substrate;
etching the first side of the foam sheet to form a textured pattern; and
applying a pressure sensitive adhesive to the second side of the at least one semi-rigid substrate, where the pressure sensitive adhesive allows the wallcovering panel to be secured to a wall surface, and where the wallcovering panel is peelably removable from the wall surface without damage to the wall surface.

18. A wallcovering panel, comprising:
a first portion including a first side, where the first portion has a first density;
a second portion including a second side opposite the first side of the first portion, where the second portion is integrally formed with the first portion, and where the second portion has a second density that is different than the first density;
an adhesive disposed on the second side of the second portion, where the adhesive allows the wallcovering panel to be removably coupled to a wall surface without damage to the wall surface; and
a pattern etched into the first side of the first substrate.

19. The wallcovering panel of claim 18, wherein the first density of the first portion is less than the second density of the second portion.

20. The wallcovering panel of claim 18, wherein the second density of the second portion comprises a semi-rigid portion.
